(19) United States
(12) Patent Application Publication
(10) Pub. No.: US 2013/0030786 A1
(43) Pub. Date: Jan. 31, 2013

(54) EMULATING INPUT/OUTPUT COMPONENTS

(71) Applicants: Irwan Halim, Houston, TX (US); Norman P. Brown, Tomball, TX (US); William R. Whipple, Magnolia, TX (US)

(72) Inventors: Irwan Halim, Houston, TX (US); Norman P. Brown, Tomball, TX (US); William R. Whipple, Magnolia, TX (US)

(21) Appl. No.: 13/193,997

(22) Filed: Jul. 29, 2011

(51) Int. Cl. G06F 9/455

(52) U.S. Cl. 703/24

(57) ABSTRACT

Example embodiments disclosed herein relate to emulating an input/output component of a device. The device includes an external connection to connect the device to another device. The device also includes multiple input/output components. One of the input/output components is selected. The selected input/output is emulated for the other device.

### BACKGROUND

Manufacturers are challenged to deliver quality and value to consumers, for example by including various features in the manufacturer's devices. To add such features, many manufacturers add expansion interfaces, for example, a Universal Serial Bus (USB) interface or a networking interface. Some servers allow for client computers to access features of the server via the networking interface. For example, a client machine can install Virtual Network Computing (VNC) client software to use features of a server running corresponding VNC server software.

### BRIEF DESCRIPTION OF THE DRAWINGS

The following detailed description references the drawings, wherein:

FIG. 1 is a block diagram of a system including a host machine capable of selectively sharing input/output components, according to one example;

FIGS. 2A and 2B are block diagrams of devices capable of selectively sharing input/output components, according to various examples;

FIG. 3 is a flowchart of a method for selectively emulating input/output components of a device, according to one example;

FIG. 4 is a flowchart of a method for providing access to an input/output component of a device, according to one example; and

FIG. 5 is a block diagram of a computing device for emulating an input/output component of a computing device as a virtual device based on a target device, according to one example.

### DETAILED DESCRIPTION

Many people, such as salespersons and engineers travel with electronics. On many occasions, these users demonstrate a device to others. During their travels, the individual users may need to communicate with the device. As such, the user may carry a portable display, a keyboard, a mouse, or other input and/or output (I/O) devices. These peripheral devices can be bulky and/or add to the user's load. Further, users of electronics may find it advantageous to pack light during their travels. Moreover, many users, while traveling, carry personal computers, such as laptops, tablet or slate computing devices, mobile devices, etc.

Accordingly, various embodiments disclosed herein relate to utilizing personal devices as peripheral devices. As such, the user need not carry extra devices while traveling. In this manner, a user can use the monitor, keyboard, mouse, storage, etc. of a laptop. Further, the personal device can be configured to emulate a particular type of peripheral device that is compatible with the device target. For example, the personal device can be configured in a manner such that it represents itself as well as acts as a peripheral device that is compatible with one or more particular drivers available on the target device.

An example use for such a device includes employees that work remotely, on a customer site, travel, etc. Being mobile may require the employee to use a laptop wherever the employee is. For example, technology sales people may demonstrate a computing device that does not have an internal display and/or input devices, such as a server, a desktop, a thin client, etc. to customers. Demonstrations, training, development, etc. may require that a computing device, monitor, keyboard, mouse, etc. be carried around by the person performing the task. Instead of carrying a separate peripheral, various embodiments described herein would allow for one or more components of a user's device, such as a mobile device (e.g., a laptop), to be used by the target device.

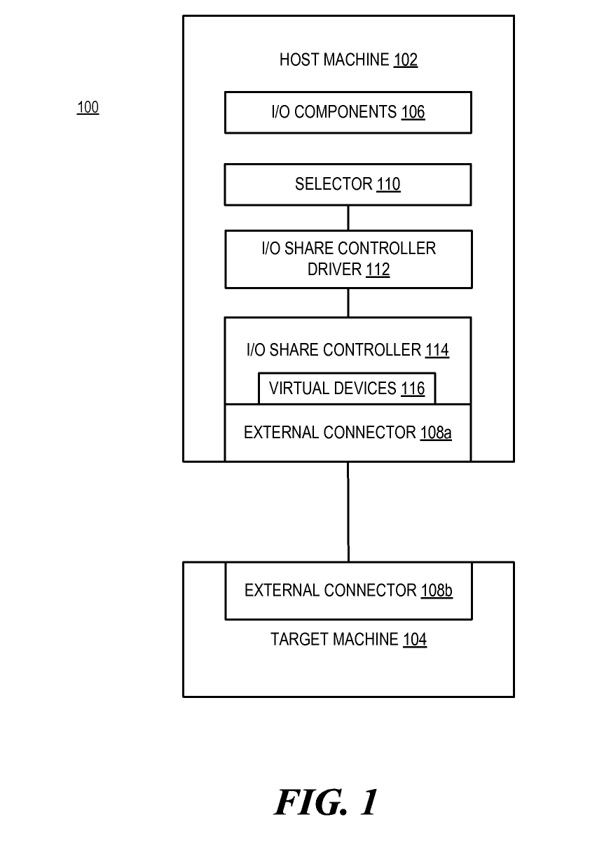

FIG. 1 is a block diagram of a system including a host machine capable of selectively sharing input/output components, according to one example. The system 100 can include a host machine 102 that communicates with a target machine 104. In certain examples, the host machine 102 and/or the target machine 104 are computing devices, such as servers, client computers, desktop computers, mobile devices, laptops, tablets, slates, etc. In other embodiments, the target devices 104 can include special purpose machines, for example, sensory devices that monitor conditions and report regularly or based on a trigger. The host machine 102 and/or target machine 104 can be implemented via a processing element, memory, and/or other components.

The host machine 102 can include one or more I/O components 106 that can be used by the target machine 104. In certain examples, I/O components 106 are parts of the host machine 102 that interact between the core (e.g., central processing unit (CPU)) of the host machine 102 and the outside world. In certain scenarios, the outside world can include I/O targeted towards humans, such as an input component (e.g., a keyboard, a mouse, etc.), an output component (e.g., a monitor, a speaker, etc.), or the like.

As previously noted, the host machine 102 can be used as a fully operational computing device, such as a laptop device or tablet. In certain embodiments, a laptop device is a personal computer that is portable and integrates a processor, memory, a display, and a keyboard. In certain examples, the laptop device may additionally include a battery, a pointing device (e.g., a touchpad, a mouse, etc.), speakers, or a combination thereof. In one embodiment, a fully operational computing device has a first mode of operation where the I/O components 106 are used by a processor of the computing device. As such, the I/O components 106 can be used in a traditional manner to implement the functions of the host machine 102.

Further, the host machine 102 can connect to the target machine 104 via an external connection. As such, the host machine 102 can include an external connector 108a that can connect the host machine 102 to an external connector 108b of the target machine 104. The external connection can be wired and may be utilized to provide communication between the host machine 102 and the target machine 104. One or more buses can be utilized for the communications. For example, a serial bus, such as a Universal Serial Bus (USB), FIREWIRE, RS-232, or the like can be used to implement the external connection. In one example, the host external connector 108a is a USB connector such as a type B connector, a Mini-B connector, a Micro-B connector, or the like. As such, in certain examples, the host external connector 108a can represent the host machine 102 as a peripheral. Other external connectors can also be present at the host machine 102 (e.g., a USB type A connection). Further, different variations of connectors can be used. Moreover, the external connector 108a can be based on other technologies and specifications, for example, USB 2.0 specifications, USB 3.0 specifications, FIREWIRE specification, or the like.

The host machine 102 can operate in multiple modes to share one or more of the I/O components 106. In one example, the host machine 102 can boot to an I/O sharing mode (e.g., as a Basic Input Output System (BIOS) option). In another example, the host machine 102 can boot to an Operating System (OS). A module of the host machine 102 can execute on the OS to allow for sharing of one or more of the I/O components 106. A shortcut, a key combination, or another input can be used to allow the target machine 104 to use one or more of the I/O components 106 via the external connection.

Both options can use a selector 110 to select one or more of the I/O components 106 to share with the target machine 104. These I/O components 106 can be virtualized using an I/O share controller driver 112 and an I/O share controller 114. One or more virtual devices 116 are created and provided, via the external connector 108a, to the target machine 104.

The I/O share controller 114, during operation of the host machine 102 in either mode, can search the host machine 102 for the I/O components 106. Hardware identifiers can be found based on the search. The hardware identifiers can be stored in a data structure such as a table and can be retrieved so that other searches are not required. Also, the I/O share controller 114 can assign one or more virtual hardware identifiers to the I/O components 106. The virtual identifiers can be used to provide to the target machine 104 via external connection. This information may also be stored in a data structure. In certain examples, the I/O components 106 can include native components of the host machine 102 as well as external components of the host machine 102 (e.g., one or more peripheral devices connected). The I/O share controller 114 can also route and/or manage portions of I/O traffic from the I/O components 106 to other portions of the host machine 102 as well as the external connector 108a and/or other external connectors.

In one example, a user turns the host machine 102 to an I/O sharing mode that uses the selector 110. This can be accomplished via a shortcut or a boot menu to boot the host machine 102 to the sharing mode. The I/O share controller driver 112 causes the I/O share controller 114 to find one or more I/O components 106 that can be virtualized. This can be implemented by causing the search to occur or by looking at the results of a previous search (e.g., a table). In certain examples, the I/O share controller driver 112 can be implemented as a set of instructions executable by a processor to allow one or more programs (e.g., a selector program executing on the host machine 102) to communicate with and/or control the I/O share controller 114. The selector 110 can then be used to select one of the I/O components 106 to emulate. As such, a list can be presented to the user to select from. The selector 110 can then receive an input to select one of the I/O components 106. Other selection mechanisms can be used, for example, a previously used I/O component can be automatically selected via a shortcut.

Further, the selector 110 can be used to select the target machine 104 and/or a particular type of virtual device 116 to emulate with the selected I/O component. In one example, the target machine 104 is selected. A data structure can include a list of target machines and associated virtual devices for which the particular target machines have drivers for. In certain scenarios, the particular target machines may have device drivers that allow higher-level programs executing on the target machines to interact with particular hardware devices. In this example, the virtual device can emulate a hardware device that the particular target machine has a device driver for. In other scenarios, the virtual device can be selected explicitly.

The I/O share controller 114 can create a virtual device 116 to present to the target machine 104. This created virtual device 116 can be based on the I/O component 106 and the determination of the type of virtual device. The creation of the virtual device 116 can include features and limitations of the I/O component 106 as well as the features and/or limitations of the target machine 104 and/or selected virtual device type. For example, the virtual device 116 can represent itself as a device that the target machine 104 has a driver for. Further, the I/O share controller 114 can emulate the device in the form of the external connection, for example, if the connection is a USB connection, the device can be emulated as a virtual USB device. This can occur even if the I/O component 106 is a different type of device.

As such, the I/O share controller 114 can act as an interface between the selected I/O component 106 and the target machine 104. The I/O share controller 114 can be implemented as software executing on a processor, as one or more hardware components, or a combination thereof. As such, in certain scenarios, the I/O share controller 114 can include hardware to convert an interface of the I/O component 106 (e.g., a Peripheral Component Interconnect (PCI), another bus, etc.) to an interface compliant to a use of the external connection. Further, the I/O share controller 114 can tweak capabilities of the created virtual device 116 to emulate instructions and/or other data between the I/O component 106 and the target machine 104. Examples of I/O components 106 that can be emulated in this manner include a keyboard, a mouse, a monitor, a storage device, or the like.

In one example, the host machine 102 is a laptop and the selected I/O component 106 is the keyboard of the laptop. Laptop keyboards include various keys that the target machine may not have a proper driver for. As such, the virtual device 116 created for the target machine 104 may be a more generic keyboard including some of the functions of the laptop keyboard. In certain scenarios, if an invalid keystroke is detected, the keystroke can be removed from any information sent to the target machine 104. Other input devices, for example, a mouse or trackpad, can similarly be emulated. Further, in a scenario where the keyboard for the host machine 102 is virtual (e.g., for a touch screen all in one computer or a touch screen slate device), the virtual device 116 presented to the target machine 104 can be a generic keyboard.

In another example, the I/O component 106 is a monitor. The monitor can be associated with a graphics bus. The graphics bus can be connected to a graphics processor on the host machine 102. In this example, the I/O share controller 114 can include access to the graphics bus and/or the graphics processor. In the case of access to the graphics bus, the virtual device 116 created for the monitor can be a monitor device, where the input via the external connector 108a is a graphics bus input, such as a Video Graphics Array (VGA), Digital Visual Interface, etc. In the case of access to the graphics processor, the virtual device 116 created for the monitor I/O component 106 is the graphics processor. As such, the virtual device 116 can be identified to the target machine 104 as a graphics processor and/or a graphics processor with an attached monitor. The I/O share controller 114 can be used as an intermediary to drive the graphics processor to provide a display of information received from the target machine 104 via the external connection (e.g., a USB connection). The display information can be based on a driver available at the target machine 104. In other examples, the target machine 104 may have a video output available that can be attached to a video encoder that can provide information to the host machine 102 via the external connector 108a of the host machine 102.

In yet another example, the I/O component 106 is a speaker and/or microphone and the target machine 104 is a phone. The phone may have a broken microphone and/or speaker and the user may wish to use these components of the host machine 102 to provide these capabilities. Further, the phone may have a USB port that may be used to connect with peripheral devices. Moreover, the phone may have the capability to use a USB connection to drive a microphone and/or speaker. The phone can be connected to the host machine 102 via the external connectors 108 and the host machine 102 can generate a virtual device 116 that uses the speaker and/or the microphone. The virtual device 116 can be specific to the phone. For example, the features virtual device 116 can be chosen based on drivers existing on the phone.

In certain examples, multiple I/O components 106 can be emulated to create a single virtual device 116. Further, multiple I/O components 106 may be used to create multiple virtual devices 116. Moreover, a hub or switch virtual device can be created to allow multiple I/O components 106 to be virtualized for use with the target machine 104.

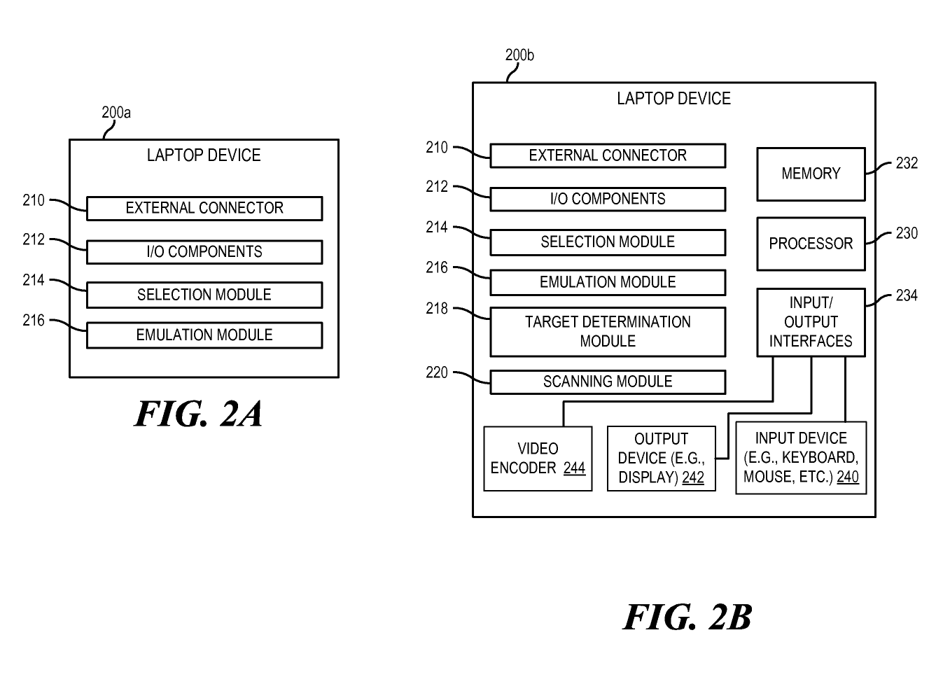

FIGS. 2A and 2B are block diagrams of devices capable of selectively sharing input/output components, according to various examples. Devices 200a, 200b include components that can be utilized to selectively share components of the respective device 200a, 200b with other devices. It is contemplated that modules and components of the device 200a, 200b can be used in various computing devices, such as laptop devices, desktop computers, tablet computing devices, mobile computing devices, and computing device 500.

The device 200 can include an external connector 210 to connect the device 200 to another device (e.g., a target device). This connection can enable the use of one or more I/O components 212 of the device 200 at the target device. The external connector 210 can be associated with a bus and/or interface, such as USB. The external connector 210 may additionally be configured in a manner such that it represents a peripheral side of a connection to the target device. For example, the external connector 210 can be a USB Type B, Mini-B, Micro-B, etc. connector. Other interfaces, specifications, standards, etc. (e.g., Serial Advanced Technology Attachment (SATA), serial, etc.) can similarly have different connectors. For example, a micro-B USB 3.0 connector may be used.

The device 200 includes a plurality of I/O components 212. These I/O components 212 can include input devices such as a keyboard, a mouse, a touchpad, a camera, microphone, etc., output devices such as a speaker, a monitor, etc., and input and output devices, such as a network access card, storage such as a card reader or hard drive, etc. One or more of these I/O components 212 can be configured to work with a selection module 214 and an emulation module 216 to provide access of the I/O components 212 via the external connector 210 to a target device. Each of the I/O components 212 can be associated with a component type. For example, a specific keyboard component can be of the keyboard component type, while a touchpad may be considered a pointing device component type.

The selection module 214 can be used to select one of the I/O components 212. The emulation module 216 then emulates the selected I/O component as a virtual device. Further, the virtual device can be identified as a peripheral device to the target device via the external connector 210. In certain scenarios, the virtual device includes a virtual hardware identifier that can be used for the identification. In other scenarios, a handshake procedure between the virtual device and the target device can be used to implement the identification.

Further, the emulation module 216 can translate communications between the target device and the selected I/O component 212. As such, the emulation module 216 can interface between the selected I/O component 212 and the target device. In certain scenarios, the interface used by the selected I/O component 212 is different than the interface presented via the external connector 210. In these scenarios, the emulation module 216 can translate between one interface (e.g., a graphics bus interface, a keyboard controller interface, etc.) to another interface (e.g., a USB interface). Moreover, the emulation module 216 may have the capability to translate between one or more I/O components 212 of different types and the interface associated with the external connector 210. In the case where the external connector 210 is associated with a serial bus interface (e.g., USB interface), the virtual device can be represented as a serial bus virtual device to the target device.

The emulation of the selected I/O component 212 can be based on the target device. A target determination module 218 can be used to determine a device type associated with the target device. Further, the target determination module 218 can determine one or more device drivers associated with the other device. In certain scenarios, a data structure (e.g., a table or linked list) can be used to associate target devices with device drivers available on the target device. Moreover, a data structure can include device drivers that can be selected. As such, in certain scenarios, the target device need not be selected and an associated device driver available on the target device can be selected by a user. The emulation module 216 can emulate the selected I/O component 212 as a virtual device that is compatible with the driver or a driver available on the target device. With this approach, users of the device 200 can be assured that the components to be used by the target machine, via the virtual device, are compatible with the target machine.

The I/O components 212 can be determined by a scanning module 220. The scanning module 220 can determine hardware identifiers associated with the I/O components 212. Some of the I/O components 212 can be native to the device 200 while other I/O components 212 can be external, for example, connected via an external bus system (e.g., a Secure Digital card reader). The scanning module 220 can also generate a list of the components for use by the selection module 214. Further, once selected, the emulation module 216 can generate a virtual hardware identifier for the selected I/O component 212. Moreover, an identifier can be associated with the hardware component describing the component as native or external.

A processor 230, such as a central processing unit (CPU) or a microprocessor suitable for retrieval and execution of instructions and/or electronic circuits can be configured to perform the functionality of any of the modules 214-220 described herein. In certain scenarios, instructions and/or other information, such as information about target devices, drivers associated with the devices, etc. can be stored in memory 232 or other storage. Input/output interfaces 234 may additionally be provided by the device 200b. For example, input devices 240, such as a keyboard, a sensor, a touch interface, a mouse, a microphone, etc. can be utilized to receive input from an environment surrounding the device 200b. Further, an output device 242, such as a display, can be utilized to present information to users. Examples of output devices include speakers, display devices, amplifiers, etc. Moreover, in certain embodiments, some components can be utilized to implement functionality of other components described herein.

In certain examples, a video encoder 244 can be connected to the input/output interfaces 234. The video encoder 244 can be internal to the device 200 or external. In one example, the video encoder 244 is external to the device 200. In this example, the video encoder 244 may have a connector that can be compatible with a video out of the target device and another connector that can connect the target device to the device 200 via the external connector 210. The video encoder 244 can represent a device and driver that can be selected by the target determination module 218. In another example, the video encoder 244 can be onboard the device 200.

Each of the modules 214-220 may include, for example, hardware devices including electronic circuitry for implementing the functionality described herein. In addition or as an alternative, each module 214-220 may be implemented as a series of instructions encoded on a machine-readable storage medium of device 200 and executable by processor 230 or other hardware controllers. It should be noted that, in some embodiments, some modules are implemented as hardware devices, while other modules are implemented as executable instructions. For example, the emulation module 216 may include a controller executing instructions that uses hardware to convert logical signals between two different types of communication interfaces (e.g., a parallel bus and a serial bus).

With the above approaches, components of the device 200 can provide peripheral capabilities to a target device. The target device need not be specifically compatible with the particular components. With these approaches, the device 200 can identify the components as other components for which the target device is compatible and can provide services that the target device can understand. Further, the device 200 emulates the component as a compatible peripheral device.

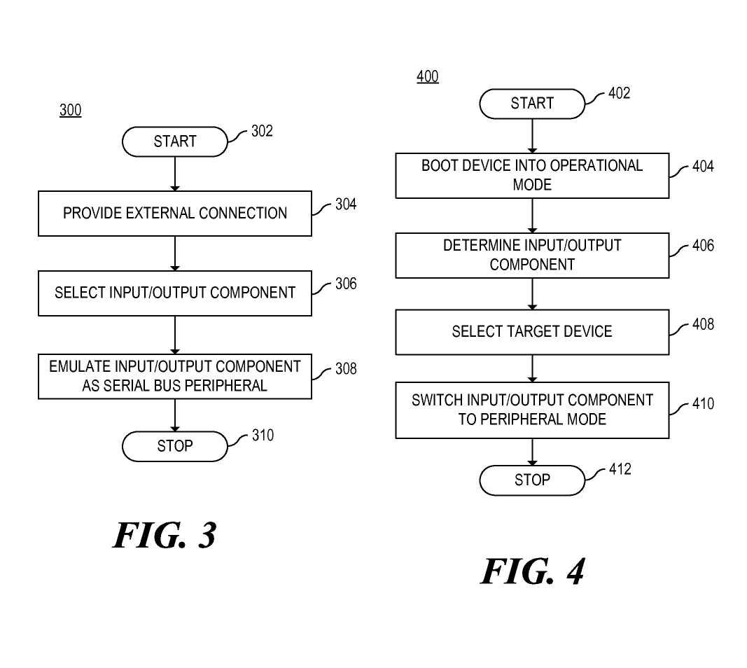

FIG. 3 is a flowchart of a method for selectively emulating input/output components of a device, according to one example. Although execution of method 300 is described herein with reference to a host device, the method 300 can be performed by other suitable devices, for example, device 200, host machine 102, computing device 500, etc. Method 300 may be implemented in the form of executable instructions stored on a machine-readable storage medium, and/or in the form of electronic circuitry.

Method 300 may start at 302 and proceed to 304, where a host device may provide an external connection to connect the host device to another device, for example, a target device. As noted above, the connection can be a USB connection. Further, the host device may be a fully functioning computer, such as a laptop device or tablet computer. The host device includes multiple I/O components. At least some of the I/O components can be shared. Example sharable I/O components include a keyboard and a monitor. Other example I/O components can include storage, cameras, other sensors (e.g., accelerometers), a pointing device, a network connection, or the like. These I/O components may be native or external. A scanning module of the host device can determine a set of the I/O components that can be shared and store identifiers of the I/O components in a data structure.

At 306, a selection module of the host device can select one of the I/O components. The selection can be from scanning the data structure. For example, a selection display can be presented to a user including an identifier of one or more of the I/O components. A user input can be used to select the I/O component.

Then, at 308, an emulation module can emulate the selected I/O component via the external connection. In certain examples, the emulation is of a serial bus (e.g., USB) peripheral I/O device accessible via the external connection between the host device and the target device. As noted above, an emulation module can create a virtual device that emulates the I/O component as the peripheral device. Further, a user may be provided an option to select properties of the virtual device. For example, the properties can be determined by selecting the target device, allowing the host device to emulate a peripheral device known to the target device. The emulation module can interface between communications to/from the target device and the I/O component. For example, while communicating via the external connection, the emulation can translate communications between the target device and the selected I/O component. The translation can include, for example, removing commands that are unknown to the target device from communications. Other commands can be used to provide similar functionality.

For example, in the case of the I/O component being a keyboard device, the keyboard may have additional keys specific to the host device (e.g., laptop function keys). These keys, when pressed can perform another function and/or may be removed from communications with the target device based on drivers available at the target device. Moreover, the I/O component can be represented as a standard serial bus peripheral device. In certain examples, a standard serial bus peripheral device is a device that corresponds to a particular standard. This standard serial bus peripheral device representation can be stripped of some of the features of the I/O component. The method 300 continues to 310, where the method 300 is complete. In other embodiments, the method 300 can include steps in lieu of or in addition to those noted above.

FIG. 4 is a flowchart of a method for providing access to an input/output component of a device, according to one example. Although execution of method 400 is described herein with reference to a host device, other suitable components for execution of method 400 can be utilized (e.g., computing device 500, device 200, etc.). Method 400 may be implemented in the form of executable instructions stored on a machine-readable storage medium and/or in the form of electronic circuitry.

Method 400 may start 402 and proceed to 404, where the host device boots to an operational mode. In one example, the host device is a laptop device and booting into an operational mode includes booting to an operating system where one or more of the host device's I/O components can be used. As noted above, at least some of the I/O components can be native to the host device. For example, a laptop device may include a native keyboard, monitor, pointing device, storage, and a networking connection. In another example, a tablet device may include a native storage, touch screen display, and networking.

A program or other routine can be run to provide access of one or more of the I/O components to a target device. The program can be an Operating System routine, middleware, or the like. The program can also be executing and triggered into a peripheral mode by a command (e.g., a keyboard combination). When in the peripheral mode, one or more of the I/O components provided as I/O to a target device via emulation. Another command can be used to revert the operation of the host device to the operating mode.

When the peripheral mode is triggered, at 406, an I/O component can be determined or selected. As noted above, the selection can be based on a data structure (e.g., a list), user input, scanning, or a combination thereof. The selection can be based on a Graphical User Interface (GUI). For example, identifiers of the I/O components can be presented. One of the identifiers can then be selected. Confirmations can also be displayed on the GUI.

At 408, a target device can be selected. The target device can be selected from a list. Further, a data structure can include capabilities of the target device. The target device can also be selected via a GUI. With this approach, the emulated virtual device provided to the target device can be customized for the target device and compatible with the target device. Additionally or alternatively, a specific peripheral virtual device for the I/O component can be selected instead of the target device. To implement this, the I/O component can be selected and a list of possible virtual devices for the I/O component can be selected. In certain scenarios, the virtual devices and/or target device information can be downloaded from another location (e.g., as an update). The user can then select a virtual device for which the target device has a driver for.

At 410 the host device determines to switch and switches the selected I/O component to a peripheral mode. In the case of a monitor and/or graphics engine being the I/O component emulated, the monitor can present information received via an external connection from the target device. In the case of a keyboard device, key information received as input can be routed to the target device. Thus, communications information of the selected I/O component can be rerouted from being associated with the host device to being associated with the target device. In certain scenarios, an input (e.g., a key combination) or other trigger (e.g., a timer) can return the host device to the operational mode. The method 400 then proceeds to 412, where the method 400 stops.

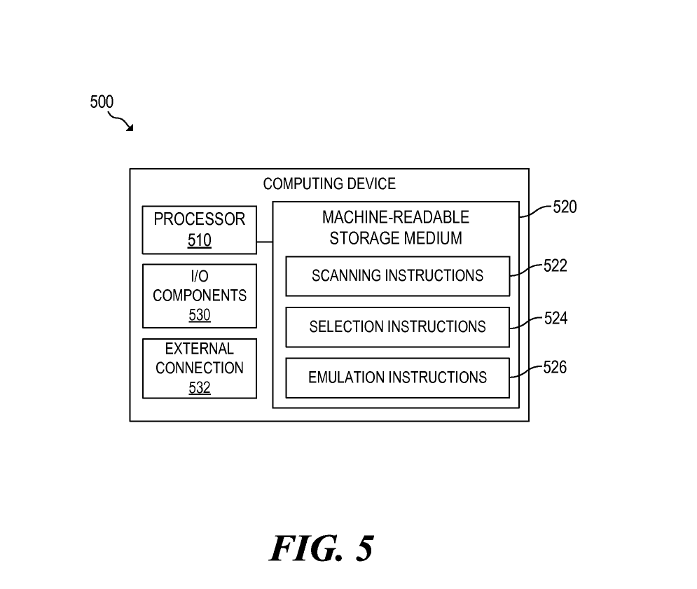

FIG. 5 is a block diagram of a computing device for emulating an input/output component of a computing device as a virtual device based on a target device, according to one example. The computing device 500 includes, for example, a processor 510, and a machine-readable storage medium 520 including instructions 522, 524, 526 for emulating one of multiple I/O components 530 of the computing device as a virtual device for use with the target device via an external connection. Computing device 500 may be, for example, a laptop device such as a notebook computer or a net book, a slate computing device, a portable reading device, a wireless email device, a mobile phone, or any other computing device.

Processor 510 may be, at least one central processing unit (CPU), at least one semiconductor-based microprocessor, at least one graphics processing unit (GPU), other hardware devices suitable for retrieval and execution of instructions stored in machine-readable storage medium 520, or combinations thereof. For example, the processor 510 may include multiple cores on a chip, include multiple cores across multiple chips, multiple cores across multiple devices (e.g., if the computing device 100 includes multiple node devices), or combinations thereof. Processor 510 may fetch, decode, and execute instructions 522, 524, 526 to implement methods 300 and 400. As an alternative or in addition to retrieving and executing instructions, processor 510 may include at least one integrated circuit (IC), other control logic, other electronic circuits, or combinations thereof that include a number of electronic components for performing the functionality of instructions 522, 524, 526.

Machine-readable storage medium 520 may be any electronic, magnetic, optical, or other physical storage device that contains or stores executable instructions. Thus, machine-readable storage medium may be, for example, Random Access Memory (RAM), an Electrically Erasable Programmable Read-Only Memory (EEPROM), a storage drive, a Compact Disc Read Only Memory (CD-ROM), and the like. As such, the machine-readable storage medium can be non-transitory. As described in detail below, machine-readable storage medium 520 may be encoded with a series of executable instructions for emulating one of the I/O components 530.

A plurality of I/O components 530 of the computing device 500 are determined. In certain scenarios, scanning instructions 522 can be executed to determine the I/O components 530. In other scenarios, the I/O components 530 can be determined from a data structure. Further, the data structure can be populated by executing the scanning instructions 522. In this scenario, the processor 510 can use components of the computing device 500 to determine I/O components 530 that may be shared with another device via the external connection 532. As such, hardware devices that are associated with a bus or other interface of the computing device 500 can be searched for. Identifiers of these I/O components 530 are stored in the data structure.

The computing device 500 can enter a mode to provide one or more of the I/O components 530 as peripheral devices for another computer connected via the external connection 532. It can be determined that the other device is connected via the external connection. Selection instructions 524 can be used to select one of the I/O components 530 to emulate as a virtual device.

Then, emulation instructions 526 can be executed by the processor 510 to generate the virtual device based on the selected I/O component. The emulation instructions can be used to determine a driver interface compatible with the other device. The virtual device can also be based on the determined driver interface. In certain scenarios, the driver interface is determined by a selection of the other device and/or the driver. For example, a user can be provided a list of devices to choose from, where the other device is on the list. The list can be searched and/or sorted based on user choices. Further, drivers and/or virtual devices that are compatible with the other device can be presented as options to the user. Additionally or alternatively, the virtual device and/or compatible drivers can be selected automatically based on a determination of the other device.

Then, the emulation instructions 526 cause the processor 510, a set of other processors (e.g., a controller, a graphics processor, etc.), etc. to emulate the selected I/O component based on the compatible driver interface. In certain examples, updates can be downloaded to determine the compatible driver interface. As such, the emulation instructions 526 can cause the processor 510 to determine a device type associated with the other device. In certain examples, a device type can include a model and/or version of the device. This information can be stored in a data structure at a server or other device that the computing device 500 can communicate with. The device type can be used to download a configuration associated with the device type. In certain examples, the configuration can include information about compatible driver interfaces and/or virtual device customization information. As such, the emulation can be based on the downloaded configuration by using the updated information to determine the virtual device.

What is claimed is:

1. A device comprising:
an external connector to connect the device to another device;
a plurality of input/output components;
a selection module to select one of the input/output components; and
an emulation module to emulate the one input/output component as a virtual device,
wherein the virtual device is identified as a peripheral device to the other device via the external connector.

2. The device of claim 1, further comprising:
a target determination module to determine a device type associated with the other device,
wherein the target determination module further determines one or more device drivers associated with the other device.

3. The device of claim 2, wherein the one input/output component is further represented as the virtual device for which the other device has a device driver.

4. The device of claim 1, wherein the emulation module translates communications between the other device and the one input/output component.

5. The device of claim 1, further comprising:
a scanning module to determine a plurality of respective hardware identifiers associated with the input/output components,
wherein the emulation module generates a virtual hardware identifier for the one input/output component.

6. The device of claim 1, wherein the virtual device is represented as a serial bus virtual device to the other device.

7. The device of claim 1, wherein the device is a laptop device and wherein the input/output components include a keyboard, a mouse, and a monitor.

8. A method comprising:
providing an external connection at a computing device to connect the computing device to another device,
wherein the computing device includes a plurality of input/output components;
selecting one of the input/output components; and
emulating the one input/output component as a peripheral input/output device accessible via the external connection to the other device.

9. The method of claim 8, wherein the one input/output component is represented as a standard serial bus peripheral device to the other device.

10. The method of claim 9, further comprising:
communicating with the other device via the external connection,
wherein the emulation translates communications between the other device and the one input/output component.

11. The method of claim 8,
wherein the computing device is a laptop, and
wherein the input/output components include a monitor and a keyboard.

12. The method of claim 8, further comprising:
booting the computing device into an operational mode, wherein the one input/output component provides native input/output to the computing device; and
determining to switch the one input/output component to a peripheral mode,
wherein the emulation is based on the determination.

13. A non-transitory machine-readable storage medium storing instructions that, if executed by at least one processor of a device, cause the processor to:
determine a plurality of input/output components of the device;
select one of the input/output components;
determine another device to connect the device to via an external connection;
determine a driver interface compatible with the other device; and
emulate the one input/output component based on the compatible driver interface.

14. The non-transitory machine-readable storage medium of claim 13, further comprising instructions that, if executed by the at least one processor, cause the processor to:
determine a device type associated with the other device; and
download a configuration based on the device type,
wherein the emulation is based on the downloaded configuration.

15. The non-transitory machine-readable storage medium of claim 13, wherein the device is a laptop.
